(19) United States
(12) Patent Application Publication
(10) Pub. No.: US 2020/0071204 A1
(43) Pub. Date: Mar. 5, 2020

(54) Method for treating seawater by bioflocculation and flotation and corresponding installation

(71) Applicant: Veolia Water Solutions & Technologies Support, Saint-Maurice Cedex (FR)

(72) Inventors: Jerome LEPARC, Poissy (FR); Abdelkader GAID, Paris (FR); Fabien VERGNOLLE, Bois Colombes (FR)

(73) Assignee: Veolia Water Solutions & Technologies Support, Saint-Maurice Cedex (FR)

(21) Appl. No.: 16/474,087

(22) PCT Filed: Dec. 28, 2017
(86) PCT No.: PCT/EP2017/084709

§ 371 Date: Jun. 27, 2019

(30) Foreign Application Priority Data
Dec. 28, 2016 (FR) 1663452

(51) Int. Cl. C02F 1/52; C02F 3/08; C02F 1/24

(52) U.S. Cl. CPC C02F 1/5263; C02F 2103/08; C02F 1/24; C02F 3/085

(57) ABSTRACT

The method and corresponding installation allow seawater to be biologically treated in order to purify it. The use of bioflocculation make it possible to avoid using exogenous coagulation and/or flocculation agents, allows a significant reduction in the clogging power of the water treated, allows an improvement of the yield and a reduction of the quantities of sludge produced to be treated then discharged.

### FIELD OF THE INVENTION

The field of the invention is that of the treatment of water, more particularly that of the treatment of water by biological means with a view to its cleansing. The invention relates especially to the treatment of seawater. The invention relates to a method of water treatment that combines bioflocculation with a flotation treatment as well as to an installation to implement this method.

### PRIOR ART

Water can be treated by various methods of treatment using physical, chemical and/or biological means. The nature of the treatment implemented and their modes of operation can vary greatly depending on the type of water to be treated.

Methods for treating water by biological means, commonly called biological treatment methods, are implemented by the use of a biomass. There are methods of treatment by free biomass and methods of treatment by fixed biomass.

Methods of treatment by fixed biomass are implemented by the use of biological filters, commonly called biofilters or similar devices comprising a biomass carrier, i.e. a carrier to which the biomass is fixed.

Various carriers have been developed. These can be constituted of materials that have density lower than, equal to or greater than that of the water to be treated. These materials can be inorganic and they can be chosen from among the group comprising sand, gravel, glass beads or a combination thereof. These materials can also be organic, for example particles of plastic such as polystyrene particles. Carriers commonly used in biofilters are shales or clay carriers. Treatment using fixed biomass also uses the technology commercially available under the name MBBR (Moving Bed Biofilm Reactor), which especially uses “K5 carrier” type carriers.

MBBR technology is used especially for the treatment of wastewater. The designing of water treatment methods using this technology is closely dependent on the quality of the water to be treated, which especially sets the conditions for the choice of the steps of treatment and their mode of operation.

For example, methods of biomass treatment (fixed and/or free) are specific to the water to be treated. Indeed, biomass is not an inert ecosystem. It is, on the contrary, a dynamic ecosystem, the growth of which depends on the quality of the water to be treated. Thus, the biomass used to treat wastewater and the biomass used to treat seawater will have different profiles and properties.

The biomass can be constituted by a homogenous or heterogeneous biomass. It can include any microorganism capable of contributing to the treatment of water, especially bacteria and micro-algae. Biomass generally contributes to water treatment by the degradation, through biological means, of the organic pollution contained in this water.

Implementing the step of filtration by biological means is generally combined with implementing additional steps of physical and/or chemical water treatment enabling a clarification of water. These steps are implemented in a predetermined sequence. The additional steps of treatment can be chosen especially from among groups comprising filtration, decantation or settling (gravity separation), flotation, flocculation, coagulation and their combinations. The chemical treatment of water requires recourse to chemical reagents, especially coagulation agents and/or flocculation agents. These reagents generate sludges which must be treated on site (in order to reduce their volume) and then discharged. Depending on the applications, it may be necessary to discharge the sludges in special waste dumps. Additional steps of physical treatment can be chosen from among especially screening, microfiltration, nanofiltration, ultrafiltration, reverse osmosis membrane filtration and combinations thereof.

The types of steps and their sequences of implementation can vary according to the water to be treated. In particular, the treatment of seawater and that of wastewater generally have particular differences. These differences are due especially to the quality of the water. Indeed, seawater and wastewater are not types of water to be treated that are equivalent as regards their quality. This quality is generally characterized by various factors and parameters, for example turbidity, the parameter called SDI (Silt Density Index), chemical oxygen demand, nitrogen concentration and/or phosphorous concentration, the number and the size of particles in suspension in said water. Now, the quality of the water—and therefore the nature of the water to be treated—has a direct impact on the steps of biological, physical and/or chemical treatment and their operational modes.

For example, the treatment of seawater, brackish water and surface water by nanofiltration or by filtration on reverse osmosis membranes has proved to be difficult. Indeed, this water includes numerous substances constituting sources of carbon, oxygen, hydrogen, nitrogen, sulfur, phosphorous, even in low concentrations. These substances are nutrient elements favorable to microbial growth. The treatment of this water by nanofiltration or by filtration on reverse osmosis membrane is therefore generally accompanied by a gradual clogging of the membranes, commonly called biofouling. This requires frequent cleansing of the membranes, leads to their premature ageing and ultimately requires their replacement. The implementation of a preliminary step of biofiltration has proved to be of relative interest, the clogging capacity of the water to be treated being essentially diminished: cf. the article by de K. J. Chinu et al., “Biofilter as Pretreatment to Membrane Based Salinisation: Evaluations in terms of Fouling Index”, Desalinisation 249 (2009) 77-84.

The implementing of methods comprising multiple steps of treatment—including steps of physical, chemical and biological treatment—is complex in its design (with numerous zones of treatment) and costly in its operational mode (in terms of supplies of chemical reagents, the replacement of the membranes, the discharge and/or treatment of sludges generated at each step). Those skilled in the art are therefore constantly in search of improved solutions that can be transposed to the industrial-scale treatment, enabling especially an optimizing of the yields of the steps implemented, a reduction in the number of steps necessary and a limitation of the quantities of reagents used. The limitation or even the absence of recourse to chemical flocculation and/or coagulation agents is particularly sought after. Besides, the use of certain synthetic flocculation agents is already prohibited in certain countries, especially Spain, the Scandinavian countries and India.

There is a known laboratory method enabling the treatment of water by flocculation using biological means, also called bioflocculation, followed by multi-layer granular filtration. Cf. E. Bar-Zeev et al., “Bioflocculation: Chemical free, pre-treatment technology for the desalination industry”, Water Research 47 (2013) 3093-3102. This biological method and the associated device are aimed at replacing methods and devices for the pre-treatment of seawater comprising the implementing of the coagulation and chemical flocculation steps and a sand filtration step. Thus, this technique makes it possible especially to overcome the use of chemical reagents such as flocculation and coagulation agents. The treatment device comprises especially a first bioflocculation unit, called a bioflocculator.

The bioflocculation unit comprises a biomass carrier comprising a porous volcanic rock that is propitious to the growth of bacteria and to the proliferation of biofilms. In particular, the formation of an organic matrix has been observed in three grow numerous types of micro-organisms, including filamentous bacteria, cyanobacteria, yeasts, protists, or even crustaceans and sea worms. The biomass carrier then needs to be cleansed frequently, on an average once every 5 to 7 days. This cleansing is accompanied by a momentary release of aggregates, sized 15 μm to 2 mm, called bioflocs, formed especially by a matrix of polysaccharide-trapping bacteria and algae. The second step of filtration in carried out on a two-layer granular filter that enables a retention of these bioflocs but is however responsible for the clogging of this second filtration barrier. Thus, regular cleansing is also necessary.

As a consequence, despite the usefulness of this technique for the treatment of surface water, brackish water and seawater without the use of flocculents and/or coagulants, it is hard to transpose this method industrial-scale treatment for the treatment of large quantities of seawater. Indeed, this technique does not enable the continuous treatment of seawater. Furthermore, it requires recourse to frequent cleansing of the biomass carrier Finally, it leads to the release of bioflocs with high clogging capacity. Thus, to be transposed to industrial-scale application, this technique requires recourse to large-sized installations and therefore its operation would be difficult because of the frequent stoppages necessary for the cleansing of the biofilter.

### GOALS OF THE INVENTION

The invention is aimed especially at providing an improved method and corresponding installation enabling the treatment of seawater without the use of exogenous coagulation agents and/or exogenous flocculation agents through the combination of biopolymers with a flotation step.

According to at least one embodiment, it is a goal of the invention to provide a method and corresponding installation for the treatment of seawater so as to significantly reduce its clogging capacity upstream to the membranes (MF, UF, NF or reverse osmosis membranes) or upstream to a granular filtration, as compared with conventional methods in which no exogenous chemical agent is used.

According to at least one embodiment, it is a goal of the invention to provide a method and corresponding installation for a continuous treatment of seawater, that correspondingly improves the efficiency of the treatment.

According to at least one embodiment, it is a goal of the invention to provide a method and the corresponding installation for carrying out bioflocculation without requiring regular cleansing.

According to at least one embodiment, it is a goal of the invention to provide a method and corresponding installation that combines a step of bioflocculation and a step of flotation.

According to at least one embodiment, it is a goal of the invention to provide a method and corresponding installation combining a step of bioflocculation and a step of flotation upstream to a step chosen from among the following: microfiltration, ultrafiltration, nanofiltration and/or filtration on reverse osmosis membranes or granular filtration.

According to at least one embodiment, it is a goal of the invention to reduce or even eliminate the quantities of sludge requiring treatment and then removal into a special waste dump.

According to at least one embodiment, it is a goal of the invention to provide a compact and economical installation.

According to at least one embodiment, it is a goal of the invention to obtain improved clarifier efficiency.

### SUMMARY OF THE INVENTION

These goals as well as others that shall appear here below are achieved through the invention which relates to a method for the fixed-biomass treatment of seawater, combining a step of enrichment of the water to be treated with extracellular polymeric substances (EPS) and a step of flotation especially by these EPS.

The term “seawater” is understood to mean water having a concentration in dissolved organic carbon of 0.5 to 2 mg/L, a total concentration in salt of 1 g/kg or more, a total concentration in nitrogen of less than 5 mg/L, a total concentration in phosphorous of less than 2 mg/L and a turbidity of 0.5 to 2 NTU. The term “salts” is understood to mean salts constituted by anions and cations. The term “anions” is understood to mean anions chosen from among the group consisting of chloride salt, sulfate salt, hydrogen carbonate salt, bromide salt, carbonate salt, fluoride salt, hydroxide salt and their mixtures. The term “cations” is understood to mean cations chosen from among the group consisting of sodium, magnesium, calcium, potassium, strontium, lithium, rubidium, barium, molybdenum, uranium, vanadium, titanium, aluminum and their mixtures.

Seawater is distinguished from wastewater, not only by its salinity but also by the concentration in dissolved organic carbon, the total concentration in nitrogen and the total concentration in phosphorous. Wastewater relates especially to wastewater collected in public and private systems, whether of household, public or industrial origin. This water is characterized generally by a concentration in dissolved organic carbon of 50 to 300 mg/L, a total concentration in nitrogen of 50 to 80 mg/L and a total concentration in phosphorous of 5 to 12 mg/L.

According to a first aspect, the invention relates to a method for the fixed-biomass treatment of seawater, the method comprising:
a first step for making seawater to be treated transit through a first zone comprising a carrier of a boimass excreting extra-cellular polymeric substances (EPS) in order to grow the biomass and charge the water to be treated with free EPSs;
a second step for making the water charged with free EPSs transit through a second zone placed under pressurized air and/or under mechanical stirring in order to mix and flocculate the organic matter and/or the particles with the EPSs, said second step leading to the production of sludge comprising flocs and treated water; and
a third step for separating by flotation the sludge comprising the flocs from the treated water.

Preferably, the second and third steps are implemented simultaneously in a common zone, namely said second zone. In other words, the first step consists solely in the transit of seawater to be treated, and the production and excretion of free EPSs. At this stage, no flocculation and therefore no flotation is observed.

The first, second and third steps here above are implemented under atmospheric pressure. The atmospheric pressure is of the order of about 1013.25 hPa. Thus, none of these steps is implemented in a closed chamber under controlled pressure (excess pressure or low pressure).

Thus, the invention relies on an original approach which consists of the use of a biomass selected to implement a bioflocculation in two main steps and by making use of two distinct zones. This approach enables the processing of seawater to be treated in a continuous flow without requiring recourse to regular cleansing of the bioreactor. In addition, it reduces the clogging capacity of the seawater treated without recourse to exogenous chemical agents of flocculation and/or coagulation, and averts the need to remove the generated sludges towards specialized dumps. Besides, it is particularly adapted to the subsequent implementation of a step chosen from amongst the following; micro-filtration, ultra-filtration, nano-filtration and/or filtration on reverse osmosis membrane or granular filtration. Finally, it can be implemented in a compact and economical way to enable transposition to industrial scale application.

The inventors have shown especially that it is an advantage to use biomass that excrete extra-cellular polymeric substances, commonly called EPS, in the treatment of seawater.

As a corollary, it is indispensable that the totality of the biomass should be fixed to said carrier. Indeed, if the biomass is in free form, it could have a negative impact on the operation of the method, especially the steps of flocculation and flotation. Thus, the method according to the invention comprises a biomass that is totally (100%) fixed. It is therefore a method of treatment using fixed biomass. Said method is therefore devoid (0%) of biomass in free form. It is therefore not a method of treatment using free biomass. In addition, a method of treatment using exclusively fixed biomass has the advantage of limiting the production of sludge as compared with methods that also resort to free biomass.

EPSs are extra-cellular polymeric substances of biological origin participating in the formation of microbial aggregates, including biofilms. These EPSs are the main substances responsible for the functional and structural integrity of biofilms, of which they partly determine the physical/chemical and biological properties. Various classes of EPS have been identified as a function especially of the micro-organisms concerned. The most common classes of EPS have been chosen from among the group naturally present in the different types of raw water to be treated. However, among these EPS, the polysaccharides are preponderant.

On the one hand, seawater comprises nutrients which are sources of carbon, oxygen, hydrogen, nitrogen, sulfur and phosphorous. These nutrients are present in low levels as compared for example with wastewater. These nutrients will contribute to the growth of the biomass on the carrier, and increase the production and excretion of free EPSs. Since the concentrations of these nutrients are not at excessive levels, it has been observed that this does not inhibit or does not hinder the production and excretion of free EPSs. This production is furthermore possible when there is no aeration of the biomass. Thus, during the transit of the seawater to be treated through a first zone comprising the biomass carrier and being devoid of any aeration device, this seawater will get charged with free EPSs. On the other hand, the free EPSs will contribute to the flocculation of organic material and/or particles present in charged water. Indeed, during the transit of charged water through a second zone and under the combined action of pressurized air and/or mechanical stirring, sludges comprising flocs and treated water are obtained.

Thus, the present invention makes it possible to provide a method of treatment wherein the seawater to be treated contributes to the growth of the biomass on its carrier, said biomass excretes a greater quantity of EPSs the water then getting charged with EPSs in free form, its EPSs thus enabling flocculation of organic matter and particles present in the charged water by combined action with pressurized air and/or mechanical stirring, resulting in the separation of the treated water with low clogging capacity from sludges comprising flocs by flotation. Promisingly, the inventors have highlighted the fact that the treatment of seawater is mediated by the free EPSs, the production and excretion of which are promoted by seawater.

The technique according to the article by E. Bar-Zeev et al., does not make it possible to reach such a result. Indeed, an organic matrix is formed in the carrier-forming porous volcanic rock. This organic matrix comprises especially polysaccharides which are extra-cellular polymeric substances in which numerous types of micro-organisms grow and are trapped. This leads to a gradual and rapid clogging of the bioflocculation unit, leading to the need for frequent cleansing. This cleansing is accompanied by a momentary release of bioflocs, formed especially by a matrix of polysaccharides that traps bacteria and algae.

The seawater to be treated can travel through the first zone in a rising, descending, transversal and combined manner, preferably in a combined manner. The biomass carriers can especially be fluidized carriers held in suspension through their own characteristics, hydraulically, under stirring etc. 100% of the biomass is fixed on said biomass carrier. One device particularly suited to the implementing of the first steps is the device commercially available under the name MBBR (moving bed bioreactor). By way of an example, such a device is described especially in the European patent application EP2508488 filed on Apr. 4 2011. It must be noted however that there is a difference in the use of this device as compared with the prior-art uses. Indeed, the treatment of seawater relies presently on the principle of a flocculation mediated by the free EPSs excreted by the fixed biomass. On the contrary, the known utilizations, generally dedicated to the treatment of wastewater, are not dependent on such compounds.

The first zone can be placed under mechanical and/or physical stirring. On the contrary, the first zone is not placed under pressurized air. The absence of devices for injecting pressurized air in the first zone is necessary for the maintenance of conditions fostering the production and excretion of free EPSs.

In a preferred manner, the transit of the water, i.e. of the seawater to be treated and of the water charged with EPSs in free form, through the first and second zones is continuous.

The method according to the invention can be implemented in the absence of exogenous flocculent agents, especially exogenous chemical flocculent agents. Indeed, the step of flocculation of the organic material and/or particles present in charged water are possible because of the presence of EPSs in free form. The EPSs in free form act as endogenous flocculent agents.

The biomass is selected from among bacteria, micro-algae and other EPS-excreting micro-organisms. The EPS-excreting bacteria correspond to the biomass naturally present in seawater to be treated.

The EPSs can be polysaccharides.

The water to be treated is seawater.

The method and corresponding installation are particularly valuable for the treatment of seawater which generally associate granular filtration and reverse osmosis membrane filtration. Indeed, granular filtration reduces or even prevents the biofouling of the reverse osmosis membranes while the bioflocculation and flotation steps protect the granular filter, especially in the event of deterioration of the quality of raw water, while limiting the genesis of sludges to be treated and discharged into special waste dumps.

The seawater to be treated can have a temperature of 5° C. to 40° C.

The seawater to be treated can have a clogging capacity (SDI3 or silt density index) greater than 10, preferably of 15 to 30. The silt density index SDI can be determined according to the methodology described in detail in the thesis dissertation by Mathias Monnot entitled, “Conception d'une filière intensifiée par membrane pour le dessalement autonome d'eau de mer: étude du prétraitement et de son effet sur le biocolmatage” (Design of a membrane-based intensified process for autonomous seawater desalination in remote areas: study of the pretreatment and its effect on biofouling), Génie de Procédés, INSA de Toulouse, 2015, NNT: 2015ISAT0040, submitted on Aug. 30 2017, archives-ouvertes.fr (cf. pages 82 and 83). The mode of operation is described in the standardized method D4189 of the ASTM (American Society for Testing and Materials). The principle consists in measuring the time needed to filter a volume of 500 mL of water to be characterized through a cellulose ester microfiltration membrane (HAWP Merck Millipore) with a diameter of 47 mm and an average pore size of 0.45 μm at a constant PMT of 2.07 bars dead-end filtration. The SDI is computed as follows:

SDI_{tf}=(100%/t_{f})×(1−(t₁/t₂))

with t₁ corresponding to the initial time for collecting 500 mL (s); t₂ corresponding to the time needed to filter 500 mL of solution after t_{f} minute(s); t_{f} corresponding to the total time of filtration after the first measurement t₁ (3, 5 or 15 minutes).

Before use, the membranes are plunged into ultra-pure water for at least 15 minutes in order to wet the pores. A 10 L feeder vessel or tank connected to the Amicon cells is used to ensure that the volume will be sufficient for a total duration of the filtration. The standardized value of t_{f} is 15 minutes. It can also be 5 minutes.

It is considered that the value of SDI₁₅ gives the following indications for the design of the installations and their operation: >5: unacceptable and requiring additional pre-treatment operations; 3-5: particulate clogging or fouling requiring regular washings; 1-3: several months between each washing; and <1: several years without colloidal fouling.

Preferably, the second step, in which the EPS-charged water is made to transit in free form through the second zone placed under pressurized air and/or under mechanical stirring, is carried out in such a way that the residence time of water in the second zone ranges from 1 minute to 30 minutes. This second step can be combined with the third step of flotation without any change in the residence time. A residence time for the charged water between 1 minute and 30 minutes is the time necessary and sufficient to enable the flocculation, and potentially the flotation, of the organic matter and particles by the EPSs in free form.

The second step is implemented under pressurized air or under mechanical stirring under conditions commonly used for flotation.

The third step, in which the sludges comprising flocs are separated from the treated water, is done by flotation. The flocs float on the surface of the treated water. The flocs are therefore collected in the upper part of the second zone, when the flocculation and the flotation are implemented therein jointly, whereas the treated water is collected in its lower part.

The treated water has a clogging capacity SDI15 below 5.

The treated water preferably has a turbidity of less than 1 NTU, preferably less than 0.5 NTU and very preferably less than 0.2 NTU.

The method can comprise an additional step for injecting at least one part, preferably 2% to 50%, of the sludges into the first zone comprising the biomass carrier. The reinjection can be useful to reseed the biomass carrier and promote microbial growth.

As an alternative, the method according to the invention can comprise an additional step for injecting at least one part, preferably 2% to 50%, of sludges downstream into the first zone comprising the biomass carrier and upstream into said second zone placed under pressurized air and/or under mechanical stirring. This step makes it possible to maintain the available dose of bioflocculent without in any way increasing the nutrient load favorable to the growth of biofilms on the biomass carrier.

For these two additional steps, it can be envisaged to resort to intermediate treatment of the sludges to be reinjected, for example in order to inject only free EPSs.

The method can include an additional step for making treated water travel through a filtration step. The filtration step can be chosen from among a membrane filtration or a granular filtration. For example, a method combining a step of flotation with a step of granular filtration is disclosed in the patent application FR2995603 filed on Sep. 19 2012. In the case of membrane filtration, the filtration membrane can be chosen from among microfiltration, ultrafiltration, nanofiltration and reverse osmosis filtration membranes. In one particular embodiment, a step of two-layer filtration is implemented, using two different media, namely pumice stone (0.8 m, 1.2 to 2 mm) and sand (0.8 m, 0.6 mm).

The method can preliminarily include a step for conveying water to be treated, especially a step for pumping water to be treated such as seawater.

The method can also include a step of de-chlorination. This step is particularly useful when the water to be treated is seawater. The de-chlorination step neutralizes possible residues of free chlorine that might come from the seawater pumping device. Such free chlorine residues could effectively inhibit the growth of micro-organisms during the step for the growth of the biomass. Although this step generally leads to a reduction of the quantity of dissolved oxygen present in the water to be treated, there is nevertheless a significant and sufficient quantity of dissolved oxygen remaining in water to ensure its biological treatment.

The method can also include a step for collecting sludge obtained after the joint steps of bioflocculation and flotation, in a third zone, commonly called a separation vessel. In this zone, the sludges are recovered on the surface while the treated water is recovered in an underflow.

According to a second aspect, the present invention relates to an installation for the implementing of a method described here below. This installation comprises:
a first zone comprising a carrier receiving a fixed biomass excreting extra-cellular polymeric substances (EPSs);
a second mixing zone provided with a device for injecting pressurized air or a device for mechanical stirring;
a device for separating sludges from the treated water by flotation.

The first zone has no air injection device. On the contrary, it can be equipped with a mechanical stirring and/or physical stirring device.

The first zone comprises exclusively fixed biomass (100%). It is therefore devoid of free biomass (0%).

Said air injection or mechanical stirring device and said device for separating sludge from treated water can be present in one and the same unit, namely said second zone.

The device for injecting pressurized air can be chosen from among the group consisting of the use of white water using a pressurized preparation tank or any other mechanical means enabling the manufacture of white water (with a specific pump for example).

The separation of the sludges is done by flotation.

The installation comprises means for leading in seawater to be treated.

It comprises means for collecting treated water.

It comprises sludge-discharge means. It can also comprise means for recycling sludge from the second zone at the exit from the flotation system to the first zone or alternately between the first zone and the second zone.

These means can be piping systems, possibly matched with pumps and valves.

The installation can comprise a means of filtration chosen from among the following: granular filtration, or membrane filtration with membranes of nanofiltration, microfiltration or ultrafiltration or reverse osmosis filtration, or a combination thereof. The installation can comprise a means of dual filtration, for example including a first medium formed by pumice stone and a second medium formed by sand. The membrane can for example be directly connected to the means for collecting treated water. In the case of the treatment of seawater, the installation can include a means of granular filtration, followed by a means of reverse osmosis filtration.

The installation has no pressurizing means and/or depressurizing means for the first and second zones.

### LIST OF FIGURES

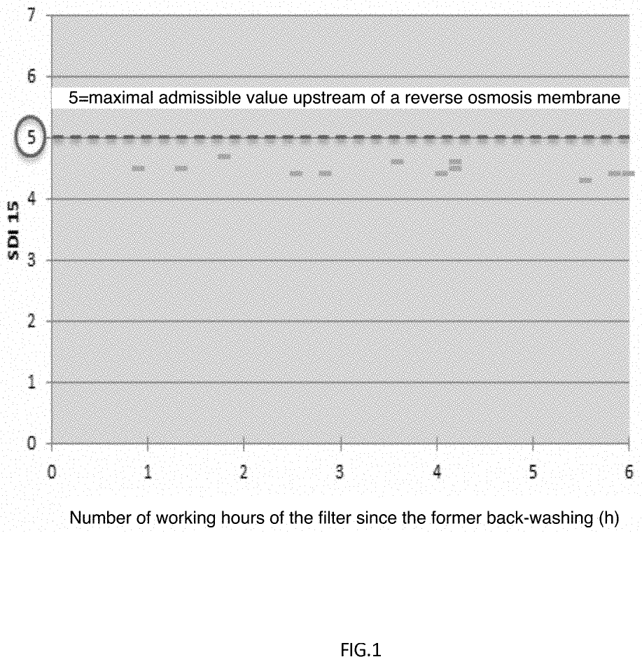

Other features and advantages of the invention shall appear from the reading of the following description of particular embodiments, given by way of simple, illustratory and non-exhaustive examples and from FIG. 1 which is a graphic representation of the SDI value of water obtained at exit from granular filtration, as a function of the number of operating hours of the filter.

### DESCRIPTION OF PARTICULAR EMBODIMENTS

The inventors have implemented a pilot installation according to the present invention, to enable the treatment of seawater.

In addition to the seawater-pumping device, said installation is formed by the following devices: a de-chlorination system, a vessel under mechanical stirring into which the biomass carriers have been added, a vessel under pressurized air, a separation vessel, a granular filtration device, a reverse osmosis membrane filtration device. Said installation does not include a device for pressurizing and/or depressurizing said vessels.

Said vessel under mechanical stirring forming the first zone according to the invention, comprises plastic biomass carriers that are fluidized and held in suspension. These carriers enable sufficient growth of micro-organisms capable of secreting EPSs in free form. 100% of the biomass that grows is in fixed form. There is therefore no biomass in free form. The quantity of biomass carrier is 50% in these trials and the contact time is about 17 minutes. More generally, the fill rate in biomass carriers could be from 2% to 70%. Even more generally, the contact time could be 1 minute to 30 minutes.

Said vessel under pressurized air, forming a second zone according to the invention, is the zone in which there occur the phenomena of: clinging of the bioflocs formed on air microbubbles and the phenomenon of flotation. It must be noted that no exogenous flocculation and/or coagulation chemical agent is added at this stage. The contact time is about 15 minutes and the flotation speed is of the order of 25 m/h.

Said separation vessel, which is a conventional vessel, enables the surface recovery of all the material capable of floating (namely sludges) and the recovery of the treated water in an underflow. The contact time is about 15 minutes.

The granular filtration time makes it possible to refine the quality of the water. It is a double (or two-layer) filtration device comprising a first filtration on pumice stone (0.8 m, 1.2 mm to 2 mm) and a second sand filtration (0.8 m, 0.6 mm). The hydraulic residence time is about 14 minutes with a filtration speed of about 14 m/h.

The reverse osmosis membrane filtration device is used to finalize the treatment of seawater in order to make it potable.

In order to appreciate the quality of the treated water obtained at exit from the granular filtration step after backwashing of the filter, the SDI value is measured (see FIG. 1). From these measurements, it can be deduced that water obtained after this the method of treatment is of a quality sufficient to enable its filtration on a reverse osmosis filter.

To be specific, the following seawater was treated:
turbidity of 0.5 to 2 NTU;
SDI3 of 15 to 30;
dissolved organic carbon of 0.5 to 2 mg/L;
total oxygen concentration below 5 mg/L; and
total phosphorus concentration below 2 mg/L.

After treatment by the method according to the invention, water having the following characteristics was obtained:
turbidity of 0.08 to 0.15 NTU;
SDI15 of 4 to 5;
number of 5-micrometer particles: from 10 to 40 per liter;
number of 1.3-micrometer particles: from 22 to 800 per liter.

In comparison, the above treatment of seawater was tested with a known technique of coagulation-flotation followed by two-layer filtration.

After treatment by the comparative method, water having the following characteristics was obtained:
turbidity from 0.1 to 0.3 NTU;
SDI15 from 5 to 6;
number of 5-micrometer particles from 20 to 120 per liter;
number of 1.3-micrometer particles from 500 to 1400 per liter.
   The treated water obtained with the method according to the invention is therefore of a quality greater than that obtained with the conventional method. The consequence of this difference in quality is an improvement in filtration performance with lower fouling of the membranes. This is observed especially by measuring head losses. Indeed in two days, the increase in pressure is 0, 2 bar for the conventional system whereas it is only 0, 1 bar with the invention.

### 7 ADVANTAGES

The technique of water treatment according to the invention provides especially an improved method and the corresponding installation enabling: the treatment of surface water, brackish water and seawater without the use of exogenous coagulation and/or flocculation agents;
the treatment of water so as to significantly reduce its fouling capacity;
the continuous treatment of water, with a corresponding improvement in treatment efficiency;
the implementing of bioflocculation, without need for regular cleaning;
a reduction of algae which are particularly fouling;
a reduction of hydrocarbons;
a reduction of microparticles;
a compactness of the installations;
the implementing of a flotation speed of 20 m/h to 50 m/h;
the improvement of the coalescence of the flocs and of the efficiency of bioflocculation;
the obtaining of biological sludges which are easier to treat and discharge;
the avoidance of the fouling of the membranes by synthetic polymers;
easier cleaning of the membranes;
the implementing of stable physical/chemical treatment despite possible fluctuations in the quality if the water to be treated.

1-16. (canceled)

17. A method of treating seawater containing organic matter and particles, the method comprising:
directing the seawater into a first treatment zone containing fixed biomass supported on biofilm carriers;
charging the seawater in the first zone with extracellular polymeric substances (EPSs) excreted by the fixed biomass;
directing the seawater having the EPSs to a second zone and mixing the seawater and EPSs through aeration or mechanical stirring;
wherein the mixing in the second zone gives rise to bioflocculation and causes floc to form where the floc includes the organic matter, particles and EPSs;
wherein the floc forms sludge;
separating the sludge in the second zone or a zone downstream from the second zone through a flotation process to yield treated seawater and the sludge.

18. The method of claim 17 wherein the bioflocculation and removal of the sludge through flotation occur simultaneously in the second zone.

19. The method of claim 17 wherein the seawater flows continuously through the first and second zones.

20. The method of claim 17 carried out in the absence of an exogenous flocculant.

21. The method of claim 17 characterized in that the fixed biomass is selected from a group comprising bacteria, micro-algae and other EPS-excreting microorganisms.

22. The method of claim 17 characterized in that the EPSs are exopolysaccharides.

23. The method of claim 17 characterized in that the seawater water to be treated has a concentration of dissolved organic carbon of 0.5 to 2 mg/L, a total concentration of salt of 1 g/kg or more, a total concentration of nitrogen of less than 5 mg/L, a total concentration of phosphorous of less than 2 mg/L and a turbidity of 0.5 to 2 NTU.

24. The method of claim 17 further including maintaining the residence time of the seawater and EPSs in the second zone at 1-30 minutes.

25. The method of claim 17 including recycling at least a portion of the sludge to the first zone and mixing the portion of the sludge with the seawater and EPSs.

26. The method of claim 17 further including the step of directing the treated seawater to a filtration device and filtering the treated seawater.

27. The method of claim 26 characterized in that the filtration device is chosen from among membrane filtration, granular filtration or combinations thereof.

28. The method of claim 27 characterized in that the filtering device is a membrane filtration device taken from the group including microfiltration, ultrafiltration, nanofiltration and reverse osmosis.

29. The method of claim 17 further including directing the treated seawater to and through a granular filtration device to produce a filtrate and directing the filtrate to a reverse osmosis filtration unit for further treatment.

30. The method of claim 17 wherein the first zone includes a moving bed bioreactor having the fixed biomass supported on the biomass carriers, and wherein there is substantially no aeration provided to the seawater in the MBBR.

31. A method of treating seawater containing organic matter and particles, the method comprising:
directing the seawater into a first treatment zone containing fixed biomass supported on biomass carriers;
charging the seawater in the first zone with extracellular polymeric substances (EPSs) excreted by the fixed biomass in the first treatment zone;
wherein the seawater and EPSs in the first treatment zone is not subject to aeration;
directing the seawater having the EPSs to a second zone and mixing the seawater and EPSs through aeration or mechanical stirring;
wherein mixing the seawater and the EPSs occurs in the absence of an externally supplied flocculant and results in bioflocculation and causes floc to form where the floc comprises the EPSs, organic matter, and particles;
wherein the floc forms sludge; and
separating the sludge in the second treatment zone or a treatment zone downstream of the second treatment zone through a flotation process that produces sludge and treated seawater.

32. The method of claim 31 wherein the EPSs excreted in the first treatment zone includes exopolysaccharides; and the method further includes recycling a portion of the sludge to the first treatment zone.
